(19) United States
(12) Patent Application Publication
(10) Pub. No.: US 2014/0087228 A1
(43) Pub. Date: Mar. 27, 2014

(54) BATTERY SYSTEM FOR A MOTOR VEHICLE

(71) Applicant: MAGNA STEYR Battery Systems GmbH & Co OG, Zettling (AT)

(72) Inventors: Harald FABIAN, Stainz (AT); Miran KOJC, Maribor (SL); Matthias PUCHER, Graz (AT); Franz STEINER, Graz (AT); Ralph WÜNSCHE, Graz (AT)

(73) Assignee: MAGNA STEYR Battery Systems GmbH & Co OG, Zettling (AT)

(21) Appl. No.: 14/033,476

(22) Filed: Sep. 22, 2013

(30) Foreign Application Priority Data
Sep. 21, 2012 (EP) EP 12185476.4

(51) Int. Cl. H01M 2/10

(52) U.S. Cl. CPC H01M 2/1083
USPC 429/99

(57) ABSTRACT

A battery system for a motor vehicle, the battery system including a first casing component having a first sidewall and a second sidewall and a base extending between the first sidewall and the second sidewall, the first sidewall having a height which is greater than the height of the second sidewall; a second casing component operatively connected to the first casing component; cell holders fixedly connected to the first casing component at the base and the first sidewall; and a plurality of cells fixedly connected to the cell holders.

### CROSS-REFERENCE TO RELATED APPLICATIONS

The present application claims priority 35 U.S.C.§119 to European Patent Application No. EP 12 185 476.4 (filed on Sep. 21, 2012), which is hereby incorporated by reference in its entirety.

### TECHNICAL FIELD

Embodiments relate to battery fixing systems, in particular, systems for the use of an uninterrupted power supply having a plurality of battery modules.

### BACKGROUND

Commonly used battery casings comprise an upper part and a lower part and are usually produced from a non-conductive material, as a rule plastic. The battery cells are arranged inside the battery casing. The upper part is fixed on the lower part in order to form a substantially rectangular container.

For using such battery systems it is generally desirable to provide a battery fixing in the battery casing.

FIG. 1A illustrates a side view of a battery system 1 corresponding to the prior art. On both side faces 22, 23 the first casing component 21 comprises moulding inclines, as are necessary in the case of castings for removal from the mould. The second casing component 11, usually a cover, is suitably connected to the first casing component 21.

U.S. Pat. No. 6,197,444 B1 discloses a battery casing comprising a pair of casing elements, which are connected together in order to form a casing for at least one battery. Each casing element comprises a pair of non-parallel sidewalls. Each sidewall of the casing elements is adapted to be positioned as bottom base wall. A pair of front walls running transversely connects the sidewalls to define an opening, in which at least one portion of a battery is arranged. There is no mention, however, of how the battery cells are fixed in the casing elements.

U.S. Pat. No. 8,110,300 B2 discloses a battery fixing system. In this system a battery container comprises a base, a mounting support wall and a fixing wall. The battery container is of a length suitable for accommodating a plurality of battery modules. The mounting support wall comprises a mounting support, which extends at least partially along a length of the container. The fixing wall comprises a fixing structure which extends at least partially along a length of the container. The mounting support is designed to engage in a first support surface, which is assigned to each of the plurality of battery modules. The fixing structure comprises a plurality of spaced holes, which are arranged in a raised portion of the fixing structure. The raised portion comprises a plurality of raised recesses; the holders are assigned to the recesses.

A disadvantage with this design is that the battery system is attached to a base plate. If the battery system is subjected to stress loading above the base plate in the event of an accident, there is a high risk of damage to the battery system.

### SUMMARY

In accordance with embodiments, a battery fixing concept is provided in which the risk of damage to the battery system is minimized.

Embodiments relate to a battery system for a motor vehicle, the battery system including at least one of the following: a first casing component and a second casing component, a first side wall of the first casing component being spatially higher in relation to a base of the first casing component than is a second side wall situated opposite the first side wall, and the battery system containing cells which can be fixed to one or more cell holders inside the first casing component, the cell holders being fixable to the base and the first side wall, or the cell holders being connectable to an auxiliary frame, the auxiliary frame being fixable to the base and the first side wall.

Embodiments relate to a battery system for a motor vehicle, the battery system including at least one of the following: a first casing component having a first sidewall and a second sidewall and a base extending between the first sidewall and the second sidewall, wherein the first sidewall has a height which is greater than the height of the second sidewall; a second casing component operatively connected to the first casing component; cell holders fixedly connected to the first casing component at the base and the first sidewall; and a plurality of cells fixedly connected to the cell holders.

Embodiments relate to a battery system for a motor vehicle, the battery system including at least one of the following: a first casing component having a base, a first sidewall and a second having a height which is less than the height of the first sidewall; an auxiliary frame fixedly connected to the first casing component at the base and the first sidewall; cell holders fixedly connected to the auxiliary frame; and a plurality of cells fixedly connected to the cell holders.

Embodiments relate to a battery system for a motor vehicle, the battery system including at least one of the following: a first casing component having a base, a first sidewall and a second sidewall, wherein the first sidewall has a height which is greater than the height of the second side wall; a second casing component operatively connected to the first casing component; an auxiliary frame operatively connected to the first casing component at the base and the first sidewall; cell holders operatively connected to the auxiliary frame; and a plurality of cells operatively connected to the cell holders.

In accordance with embodiments, a cell holder may be connected to the first casing component by a mechanical connection, such as, for example, a screw connection. This has the advantage of facilitating release of the connection, for example, for recycling the battery system. Here the cell holder may be, for example, a cooling element. At least one cell is arranged on the cell holder. The cells may be connected, for example, to the cell holder by adhesive bonding.

Alternatively, an auxiliary frame can be mechanically connected (e.g., a screwed connection) to the first casing component. Such a mechanical connection affords a further advantage, since a rigid connection is created. In the event of a possible rear-end collision, the mechanical connection may reliably absorb the acceleration and deceleration forces occurring and at least partially transmits these forces from the first casing component into the cell holder or into the auxiliary frame. In turn, the auxiliary frame transmits the forces to the first casing component, which serves to minimize the risk of damage to battery cells.

The screw points may be provided with corresponding seals in order to form a virtually sealed casing.

Any connection known to the person skilled in the art may be used as an alternative to screwed connections. This may also include for example, adhesive bonding or welding.

The first sidewall and the base of the first casing component may form an angle that is substantially a right-angle.

In accordance with embodiments, the second sidewall and the base form a predetermined angle, such as, for example, one which is greater than 90°. The second sidewall and the base may form a predetermined angle, such as, for example, an angle between 95° and 105°.

The lesser height of the second sidewall compared to the first side wall means that the relatively large angle between the second side wall and the base increases the dimensions of the battery system only slightly.

In accordance with embodiments, the first casing component is embodied as a cast part. In this case it is possible to produce thin-walled, complex component geometries with great dimensional stability whilst at the same time achieving very good strength values.

In accordance with embodiments, the second casing component is a deep-drawn part. Deep-drawn parts have an advantage that components with a very small wall thickness can be produced, thereby achieving a weight-saving.

The casing components can be produced from a metal material or from plastic, depending on the requirements. It is feasible here to use different materials for the first casing component and the second casing component.

In accordance with embodiments, the two casing components can be connected to each other. Here, the geometry of the two casing components is adapted in accordance with a joining technique. Any method known to the person skilled in the art is feasible for connecting two casing components, such as, for example, a screw connection, welding, soldering or adhesive bonding, it being possible to provide seals at the interfaces of the two casing components, and the casing components being adapted in accordance with the requirements of the various joining techniques. For example, the two casing components may comprise a circumferential flange, which may be correspondingly designed for connecting two casing components.

The casing components may serve to accommodate at least one cell, the cell being fixed to a cell holder or alternatively to an auxiliary frame. The advantage is that the cells are accommodated already assembled in the first casing component, and assembly of all the other components of the battery system, such as electronic components, cooling components and also the module connections can be done beforehand, and the second casing component only needs to be connected to the first casing component in order to complete the operation.

Embodiments are not limited to the motor vehicle industry, and may be used in non-automotive sectors, such as, for example, in shipbuilding and/or rail transport, and/or also in stationary applications such as plant construction.

### DRAWINGS

Embodiments of the invention will be explained with reference to the drawings.

FIG. 1A illustrates a side view of a battery casing in accordance with the prior art.

FIG. 1B illustrates a side view of a battery casing in accordance with embodiments.

FIG. 2 illustrates a side view of a first casing component.

FIGS. 3A and 3B illustrate a side view of a fixing concept of a first casing component and a cell holder.

FIG. 4 illustrates a side view of an auxiliary frame.

FIG. 5 illustrates a side view of a first casing component with an auxiliary frame.

### DESCRIPTION

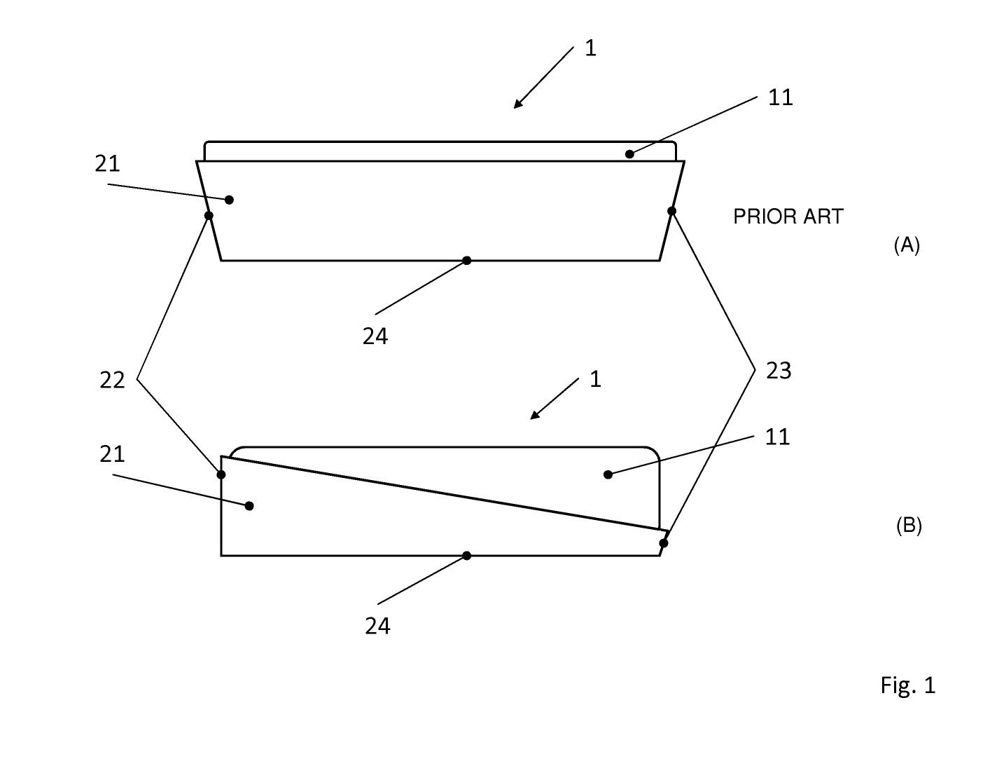

FIG. 1B illustrates a side view of a battery system 1 in accordance with embodiments. A first casting component 21 includes a first sidewall 22 which forms an approximate right-angle with a base 24, and a second sidewall 23 having a height which is less than the height of the first sidewall 22. The second sidewall 23 forms an incline M with respect to the base 24. A second casing component 11 is provided and may be produced by deep-drawing and is operatively connected, such as, for example, mechanically, to the first casing component 21.

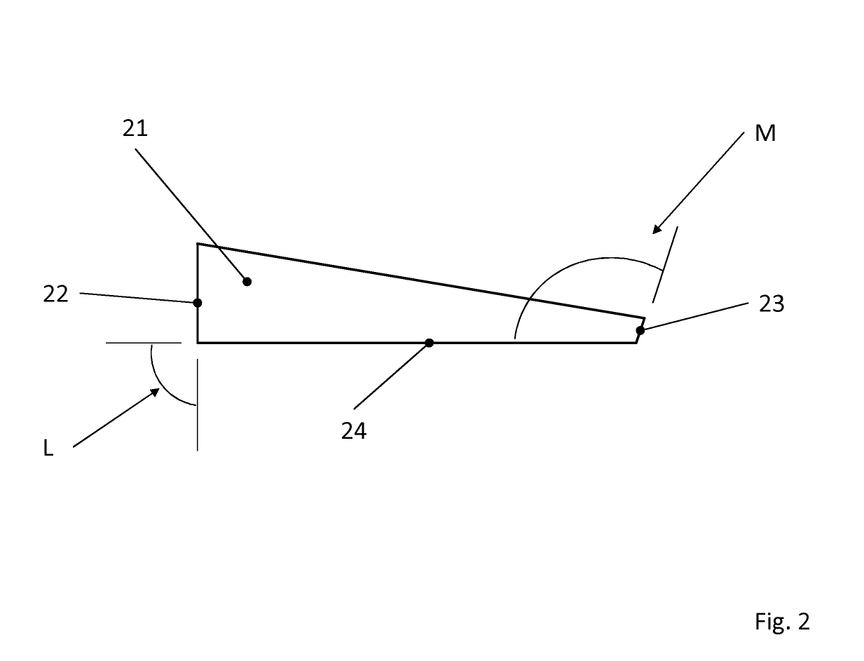

FIG. 2 illustrates a side view of the first casing component 21. The first casing component 21 is produced via a casting process. The approximate right-angle L between the first sidewall 22 and the base 24 of the casing component 21 results in the necessity of having the second sidewall 23 forming an incline M. Since the height of the second sidewall 23 is substantially less than the height of the first sidewall 22, the variation in the geometry does not have any adverse effect on the structural dimensions of the battery system, thereby affording a substantial reduction in overall space when compared to the prior art.

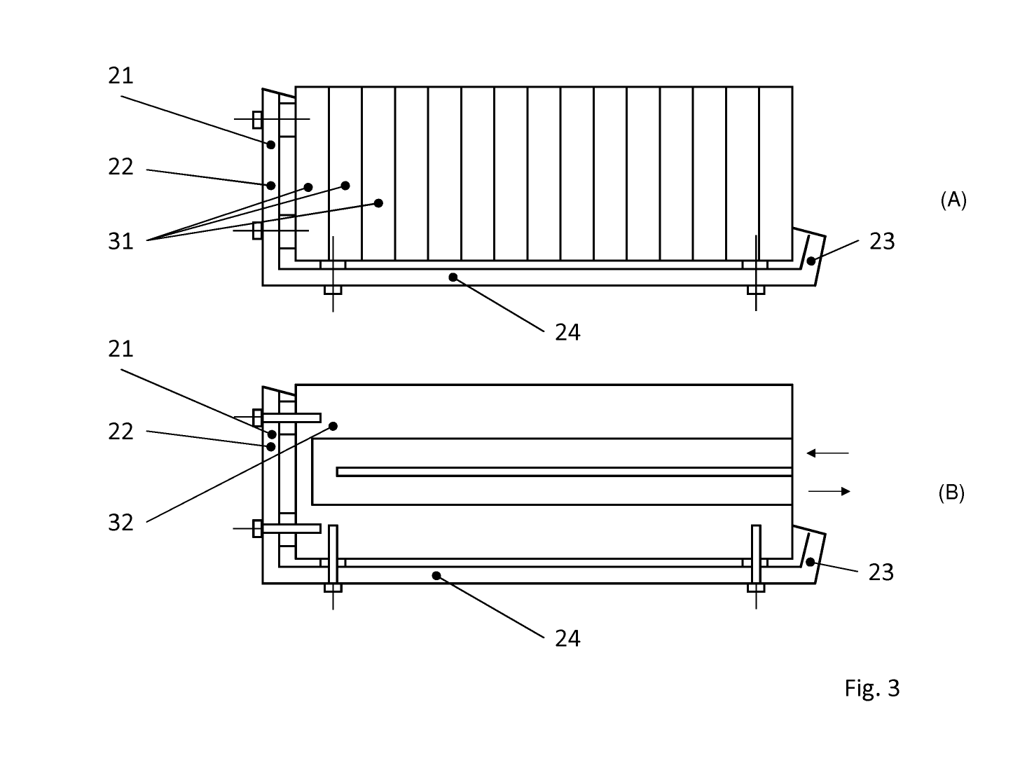

FIGS. 3A and 3B illustrate a side view of the battery system 1 in accordance with embodiments. Both representations illustrate a mechanical, such as, for example, a screw connection fixing concept.

As illustrated in FIG. 3A, a cell holder 32 comprises a plurality of cells 31, which are connected to the cell holder 32, such as, for example, by adhesive bonding. The cell holder 32 is connected to the first sidewall 22 and the base 24 of the first casing component 21 mechanically, such as, for example, by screw connection. The mechanical connection may be sealed in order to prevent any gas that escapes from the cells 31 from leaking out of the battery system 1.

As illustrated in FIG. 3B, the cell holder 32 is embodied as a cooling element. A cooling duct configured to facilitate the flow of a gaseous or liquid cooling medium is represented. The arrows illustrate the inlet and outlet direction of the cooling medium. The cell holder 32 is mechanically connected, such as, for example, screw-connected to the first sidewall 22 and the base 24 of the first casing component 21.

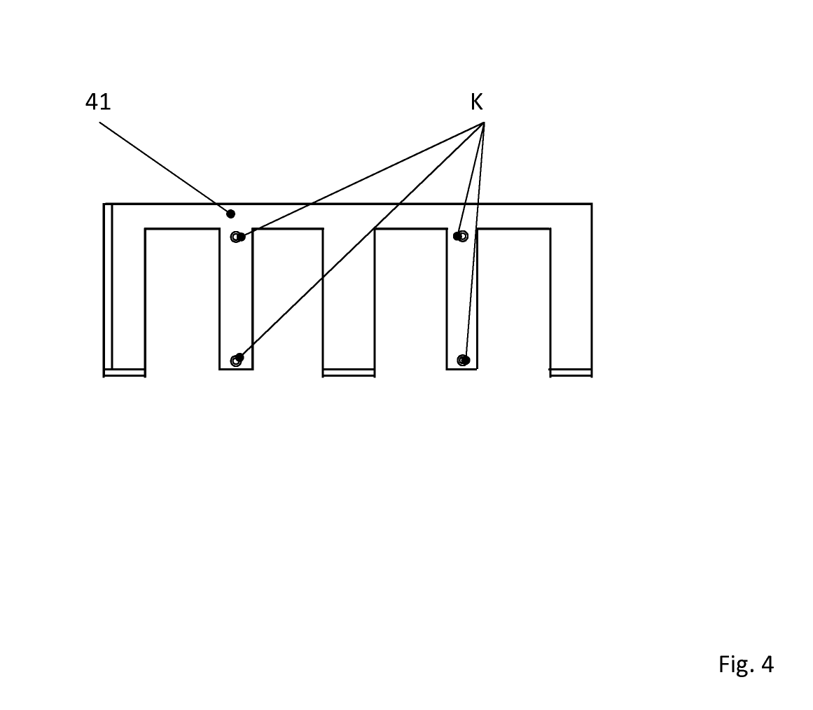

As illustrated in FIG. 4, an auxiliary frame 41 is provided which may be produced from metal material, a polymer material, a composite, or combination of the same. The auxiliary frame 41 comprises at least one mechanical connection (e.g., screw connection) K, which may be connected to a cell holder 32.

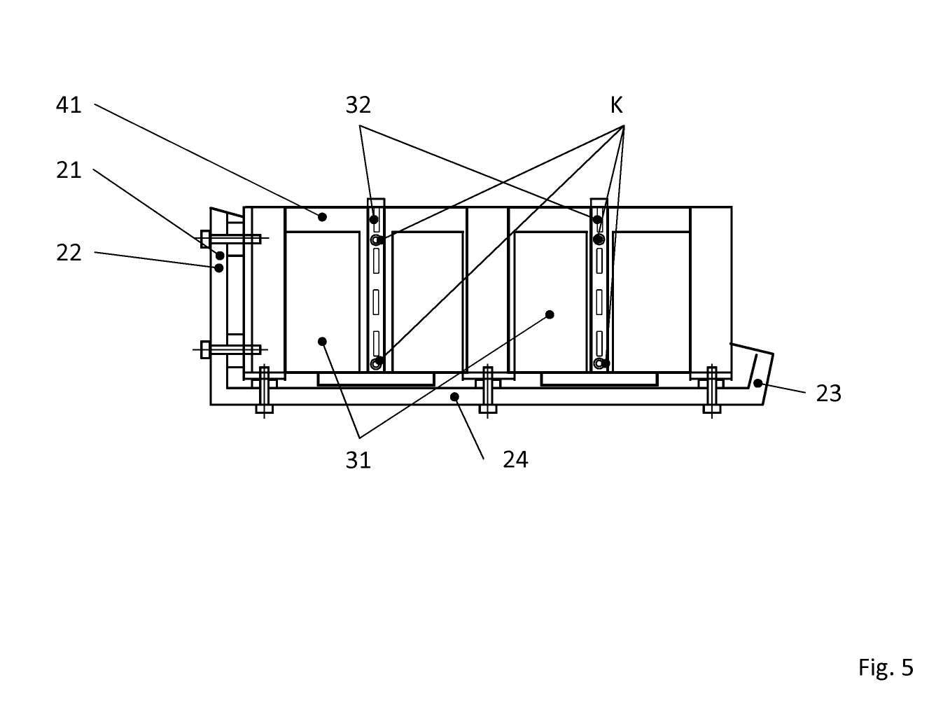

As illustrated in FIG. 5, the auxiliary frame 41 is arranged in the first casing component 21. In this example, the auxiliary frame 41 is mechanically connected to the first casing component 21 by way of a screw connection to the first sidewall 22 and the base 24 of the first casing component 21. One or more cell holders 32 may be arranged in the auxiliary frame 41. At least one cell 31 is arranged on the cell holder 32. Here, the cell holder 32 may be connected to the auxiliary frame 41 by way of at least one mechanical connection (e.g., screw connection) K. Any other possible method for connecting two components known to the person skilled in the art, for example, a plug-and-socket connection, is also feasible.

For a more secure connection, the cell holder 32 may comprise two auxiliary frames 41 situated opposite one another, the auxiliary frames 41 being of laterally inverted design.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### LIST OF REFERENCE SIGNS

1 battery system

11 second casing component

21 first casing component

22 first sidewall

23 second sidewall

24 base

31 cells

32 cell holder

33 upper mounting support

34 longitudinal web

35 transverse web

36 lower mounting support

41 auxiliary frame

L right-angle

M incline

K mechanical/screw connection

What is claimed is:

1. A battery system for a motor vehicle, the battery system comprising:
a first casing component having a first sidewall and a second sidewall and a base extending between the first sidewall and the second sidewall, wherein the first sidewall has a height which is greater than the height of the second sidewall;
a second casing component operatively connected to the first casing component;
cell holders fixedly connected to the first casing component at the base and the first sidewall; and
a plurality of cells fixedly connected to the cell holders.

2. The battery system of claim 1, wherein the first sidewall and the base of the first casing component form substantially a right-angle.

3. The battery system of claim 2, wherein the second sidewall forms an incline with respect to the base.

4. The battery system of claim 3, wherein the incline is at a predetermined angle.

5. The battery system of claim 4, wherein the predetermined angle is in a range between 95° and 105°.

6. The battery system of claim 1, wherein the first casing component comprises a cast component.

7. The battery system of claim 1, wherein the second casing component comprises a deep-drawn component.

8. The battery system of claim 1, wherein at least one of the first casing component and the second casing component is produced from a metal material.

9. The battery system of claim 1, wherein at least one of the first casing component and the second casing component is produced from a polymer material.

10. A battery system for a motor vehicle, the battery system comprising:
a first casing component having a base, a first sidewall and a second having a height which is less than the height of the first sidewall;
an auxiliary frame fixedly connected to the first casing component at the base and the first sidewall;
cell holders fixedly connected to the auxiliary frame; and
a plurality of cells fixedly connected to the cell holders.

11. The battery system of claim 10, further comprising a second casing component operatively connected to the first casing component.

12. The battery system of claim 10, wherein the first sidewall and the base of the first casing component form substantially a right-angle.

13. The battery system of claim 12, wherein the second sidewall forms an incline with respect to the base.

14. The battery system of claim 13, wherein the incline is at a predetermined angle.

15. The battery system of claim 14, wherein the predetermined angle is in a range between 95° and 105°.

16. The battery system of claim 10, wherein the first casing component comprises a cast component.

17. The battery system of claim 10, wherein the second casing component comprises a deep-drawn component.

18. The battery system of claim 10, wherein at least one of the first casing component and the second casing component is produced from a metal material.

19. The battery system of claim 10, wherein at least one of the first casing component and the second casing component is produced from a polymer material.

20. A battery system for a motor vehicle, the battery system comprising:
a first casing component having a base, a first sidewall and a second sidewall, wherein the first sidewall has a height which is greater than the height of the second side wall;
a second casing component operatively connected to the first casing component;
an auxiliary frame operatively connected to the first casing component at the base and the first sidewall;
cell holders operatively connected to the auxiliary frame; and
a plurality of cells operatively connected to the cell holders.
